(19) United States
(12) Patent Application Publication
(10) Pub. No.: US 2003/0009497 A1
(43) Pub. Date: Jan. 9, 2003

(54) Community based personalization system and method

(76) Inventor: Allen Yu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/899,345

(22) Filed: Jul. 5, 2001

(51) Int. Cl. G06F 15/00

(52) U.S. Cl. 707/513

(57) ABSTRACT

A method for assembling group of users into constructs called communities, and personalizing digital objects and content associated with a digital document, for users based on the aggregate community or communities to which they belong. The first step includes accessing hierarchical categories that include a plurality of keywords connected to categories. The next step is associating a plurality of resources with the keywords, wherein the resources refer to digital objects. Then user activities are recorded relative to an aggregate community or groups of aggregate communities to which the user belongs. Finally, digital objects are delivered to a user based on membership in the aggregate community or communities to which the user belongs.

### FIELD OF THE INVENTION

The present invention relates generally to the implicit personalization of web site information presented to a user. More particularly, the present invention relates to personalizing digital objects in web pages based on a community of users.

### BACKGROUND OF THE INVENTION

In today's highly competitive Internet environment, web sites need to be more than just mass publication pages if they want to attract and retain visitors. Successful websites need to be personalized and customized to meet individual users' interests and needs. Effective personalization should be automatically generated and content driven.

There are at least two basic types of personalization: explicit and implicit personalization. In the first case, customization is driven by information the user has explicitly given. This includes the situation where a user fills out a survey or form and a website is customized based on the information given by the user. In the second case, personalization is driven implicitly by electronic observation or data collection about the user's behavior. A brief, general background of personalization will be given next.

One way to demonstrate personalization is through an example of personalization under the context of web site personalization. Suppose a web site caters to users who are interested in outdoor sports and the web site sells sporting goods and/or provides sporting news. The web site naturally wants have a constantly changing list of merchandise, seminars, news, and clinics it promotes. Instead of having each user view the same static home page, with the same complete list of currently active promotions, the web site wants each user to see a customized page based on the user's interests. The reason the web site wants each visitor or user to see a customized page is to avoid the risk of overloading a user with generic promotions. Otherwise, the user may tune out all the web site's promotions categorically. It is more effective to custom deliver promotions or content to a user based on the user's interest. In addition, custom information delivery is a better use of precious web page screen space. Of course, regardless of the degree of customization, the web site needs to be flexible enough that anyone can (when they have the time) browse and discover new sections on the web site.

As mentioned, there are two general types of personalization: explicit and implicit personalization. An example of each as applied to the outdoors sports store example is given below. Explicit personalization requires a user to register and answer a survey to identify the user's interests. In the outdoor sports store example, the web site asks the user to identify sports in which the user is interested (e.g., biking, tennis, basketball, running, etc.). One shortcoming of this approach is that many people prefer to browse websites anonymously or do not want to register until they are ready to purchase. A second shortcoming of the registration approach is that even after a user has already registered, the user's interests may change. Statistically speaking, most users do not keep their user profiles current after they have been initially created.

Implicit personalization does not require a user to take proactive actions like filling out a survey. The user is implicitly tracked through their user ID and login or some other method of unique identification (e.g., a cookie). An implicit system only requires the web site or web server to track the areas that a user has visited. For example, if a user spends 60% of their time on the outdoor sports website in the tennis racquet section, he is probably a tennis player. The benefit of implicit personalization is that users need not be registered for it to work. In addition, users are not burdened with the responsibility to keep their profiles current. In either case, knowing that a visitor is a tennis player is invaluable when it comes to the personalization of content, such as promotions.

To produce a customized and personalized web page for each user, the system dynamically generates the web page by requesting information from a database and combining that information with web page formatting and content. The problem is each user receives a different personalized page, and every page needs to be dynamically generated. However, the cost of dynamically generating a page for each user is high and often takes a heavy toll on server performance.

A more careful observation of typical website usage reveals that not every page needs to be dynamically generated to deliver customized content. In fact, most of the personalized content that is individually crafted for a single user is often demanded by many other users with analogous interests and can be shared. By sharing cached pages, the web server does not need to make an additional database call when another user makes a similar request and the information is cached in the web site's local file system. Database access is “expensive” and it is generally a major bottleneck of website performance.

When content in the database changes, then a mechanism exists which deletes the corresponding cached file. Accordingly, the next web page call to a changed page results in a new database call and the results are stored in a newly cached file. Any subsequent requests for that specific page will result in file retrievals, not database calls. When the database content changes again, the cycle repeats.

Web servers that allow results from database calls to be cached on its file system are often referred to as cache-enabled web servers. An example of one widely used cache-enabled web server is Vignette Story Server® which uses the TCL computer language. Other web server technologies also offer caching capabilities, including the JSP (Java Server Page) and ASP (Microsoft Active Server Page) platforms.

Although the technical details of caching are not relevant to this current discussion, it is important to understand why caching is so valuable. This is because caching reusable database results in a web server's file system enhances the overall site performance because subsequent requests are satisfied by relatively “fast” file system retrievals rather than relatively “slow” database calls. In general, to gain a significant performance boost, websites must be designed to share the smallest possible subset of personalized digital components and/or web pages with the widest audience possible. In other words, it is valuable to increase the overall ratio of file system retrievals to database calls.

### SUMMARY OF THE INVENTION

The invention provides a method to track activities of users that belong to an aggregate community. The first step includes accessing hierarchical categories that include a plurality of keywords connected to categories. The next step is associating a plurality of resources with the keywords, wherein the resources refer to digital objects. Then user activities that are linked to an aggregate community are tracked to record the actual resources accessed by the users. Next, digital objects are delivered to a user based on the aggregate community's activities.

One embodiment of the invention includes a method for personalizing digital objects and content associated with a web page that is sent to users across a network. The first step includes accessing hierarchical categories that include a plurality of keywords connected to categories. The next step is associating a plurality of resources with the keywords, wherein the resources refer to digital objects. Then an aggregate community's activities are tracked based on the resources used by the aggregate community. Next, digital objects are delivered to a user based on the aggregate community's activities.

Another embodiment of the invention includes a method for personalizing digital objects and content associated with automated search results for users who belong to an aggregate community. The method includes the steps of organizing search contexts that maps a plurality of keywords to the search contexts. A following step is recording the resources accessed by the users in relation to the aggregate community to which a user belongs and the search context. Then the search results are delivered to a user based on the aggregate community's activities.

Yet another embodiment of the invention includes a method for personalizing digital objects and content to provide a community driven shopping experience that is based on the preferences shown by an aggregate community. The method includes the steps of tracking items bought by users that identify themselves as part of a predefined community, summing the preferences shown by the users belonging to that community, deducing the preferences of a community based on the sum above, and delivering the promotional sales items to community members based on the preferences shown by the broader community as a whole.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart of the steps taken to generate a personalized web page with cached components;

FIG. 2 is a database entity and relationship diagram illustrating a database structure for a cache enabled implicit personalization system;

FIG. 3 is a block diagram that illustrates the relationships between hierarchical categories, keywords and resources.

### DETAILED DESCRIPTION

For the purposes of promoting an understanding of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure are to be considered within the scope of the invention.

The current invention deals generally with implicit personalization as related to aggregated user communities. In particular, it teaches a method of tracking user “click-streams” so that a user's web experience can be influenced by the user's membership in one or more communities. Three exemplary embodiments will now be presented, with the first one described in the most detail.

### Community News Embodiment

The first embodiment implements a personalized news service that customizes and delivers news based on the level of interest an item has to a community. In this case, a biking community will be described. The system implements a high performance, implicitly personalized system that is highly integrated within the context of a cache-enabled web server. The reason the embodiment is based on a system integrated with a cache-enabled system is that personalization by its very nature is inherently processing intensive. Integrating a personalization with some type of cache-enabled server is one effective way to increase performance. For the purpose of illustrating a feasible, efficient embodiment of the invention, the embodiment will incorporate the integration of an implicit personalization system with a cache-enabled system.

Click-stream personalization is the personalization of digital objects provided to a user based on the electronic observation of user activity within a website (i.e., the sections of the website the customer visits, etc.). Digital objects are generally defined as web pages, executable scripts, graphic objects, sounds, video, documents, animations, executable objects, and similar objects which may be sent to a user from a web site. Although the concepts disclosed here are applied to HTML formatted web pages in the following embodiments, the concepts disclosed can apply equally to other types of electronic documents. These other documents include but are not limited to low resolution documents that are used with mobile and wireless devices such as PDA's, pagers, and mobile phones. In addition, this invention may also be applied to systems that serve audio documents, devices such as those used by the visually impaired, hyper documents that serve various virtual reality devices, and Internet enabled appliances. Similarly, cached components need not be stored in the HTML format as shown in the embodiment, but they can be stored in more flexible formats such as XML or even in proprietary binary formats.

A generic cache enabled personalization system includes at least three processing components: a database component, a personalization component (both logging and interpreter), and a cached data component.

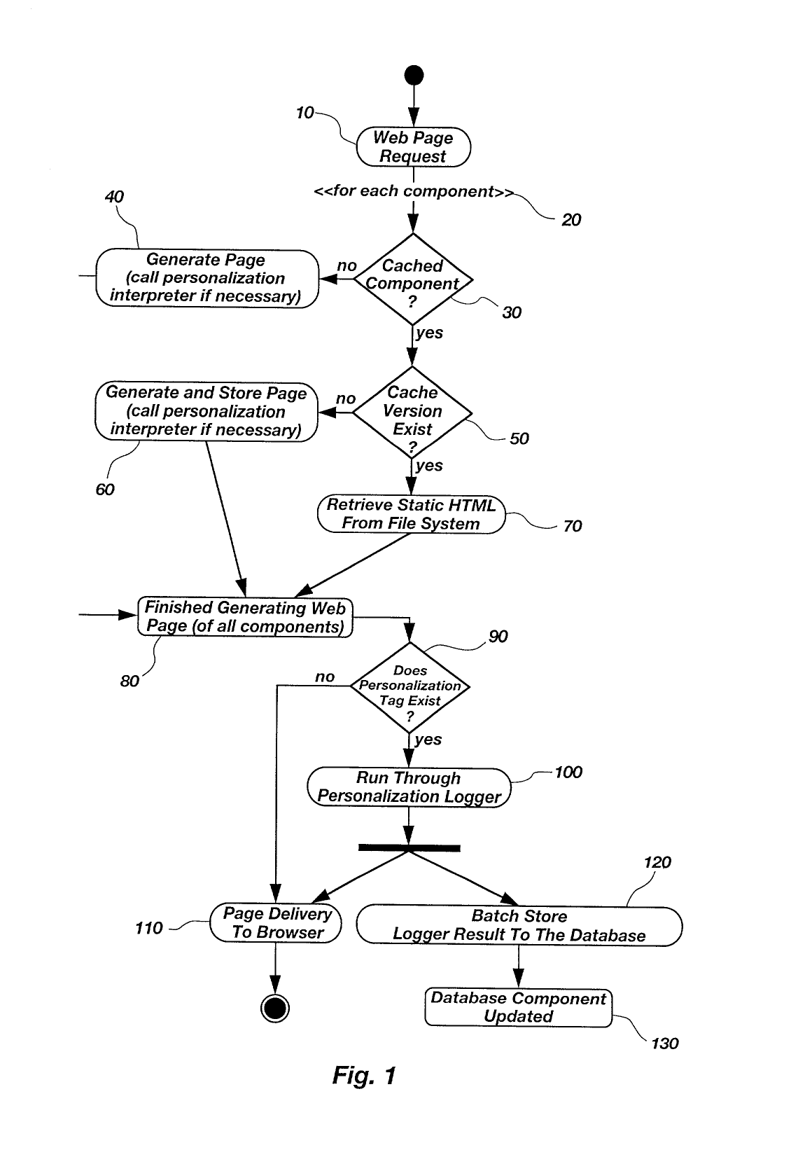

FIG. 1 is a flow chart of the steps taken by the processing components of a cache enabled personalization system to generate a personalized web page with cached digital objects. The chart illustrates the context in which the system components interact and shows the logical flow of the system. The flow chart begins with a web page request 10 and shows the steps required for page delivery. A processing component in the flow chart refers to a software routine that results in the generation of HTML snippets. A cached component refers to a component whose HTML can be cached so similar future requests can be satisfied by reading from the server's file system, rather than by making a call to the server's database system. A given web page can consist of any number of digital objects or components, but for performance and maintenance reasons these are usually kept to fewer than 6-8 per web page. It should be realized that cached components in this description are discussed generally in the context of cached HTML files, but other types of files can be used. Cached components or digital objects can be stored in formats other than HTML, such as XML, Java script, CGI script or a binary file that caches data representing information residing on an actual web page.

Referring again to FIG. 1, after a web page request is received 10, each of the page's components 20 need to be retrieved from the cache or generated by a database call. The component processing must be completed before the page as a whole can be generated and sent to the client for display. If the personalization system determines that the component or components are not cached components 30, then it generates the components for the page 40. The actual version of a personalized component to be displayed is determined by querying the personalization interpreter. The personalization interpreter will be discussed in detail later.

If the components are cached components, then the system decides if that cached component exists in the cache 50. If the cache version of the component does not presently exist, then the page must be generated and stored in the cache 60. If the component or page exists in the cache, then the page or component will be retrieved from the file system 70. Of course, retrieving a cached component is much faster than generating the components.

At this point, the components in the web page are complete 80. After page generation, but before page delivery, the system determines whether personalization tags exist in the web page to be delivered 90. If they do, the page and/or components are run through the personalization logger 100, which is responsible for implicitly logging and tracking the sections of a site the user has visited using the personalization tags. The personalization logger stores the user's activity in a database component 120, 130. It is only after properly logging the user visit that the generated web page is finally sent to the user's browser for display 110. It is important to point out that the personalization interpreter customizes content during page generation, using information stored by the personalization logger. In addition, it should be understood that a web page, in the context of cached servers, might consist of multiple personalized cached components or sub-components, each of which can be shared among unrelated users.

As discussed, the current embodiment consists of a database component (consisting of three sub-components), a cached page component (identified by keywords or concatenation of keywords), and a personalization component (consisting of logging and interpreter components). The following sections describe each of these components in more detail.

### Database Component

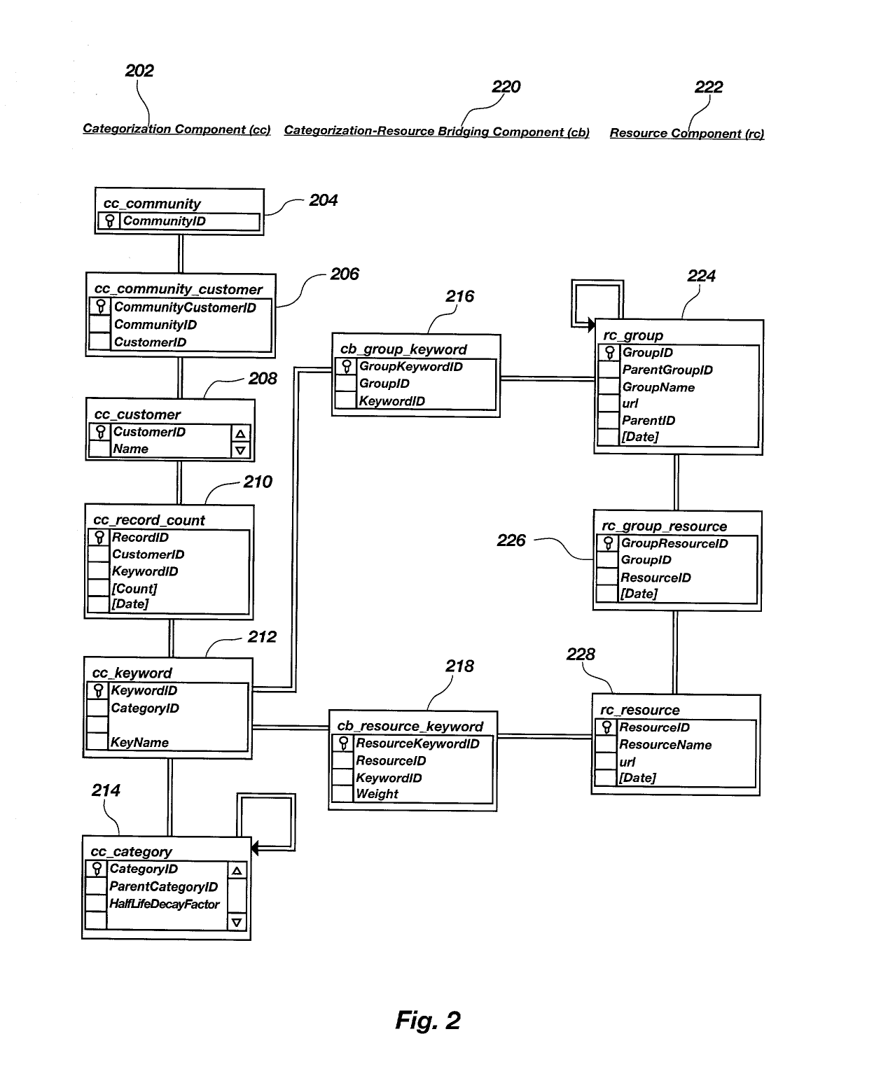

For the discussion of the database components, please refer to FIG. 2. The tables in the database schema are laid out in three columns, each of which corresponds to a database sub-component. In addition, the prefix of each table name identifies the component to which it belongs. For example, all tables in the first column belong to the categorization component and have a prefix of “cc₁₃ ” in their name.

Referring to FIG. 2, the categorization component 202 consists of at least six categorization tables. The categorization tables form the depository where customer behavior (i.e., click-stream tracking) is logged. The tracking takes place within the context of a nested tree of categories and keywords. The nested tree is provided by the cc_keyword 212 and cc_category 214 tables. A category can contain subcategories (in which case it preferably contains keywords) or keywords (in which case it preferably contains no categories).

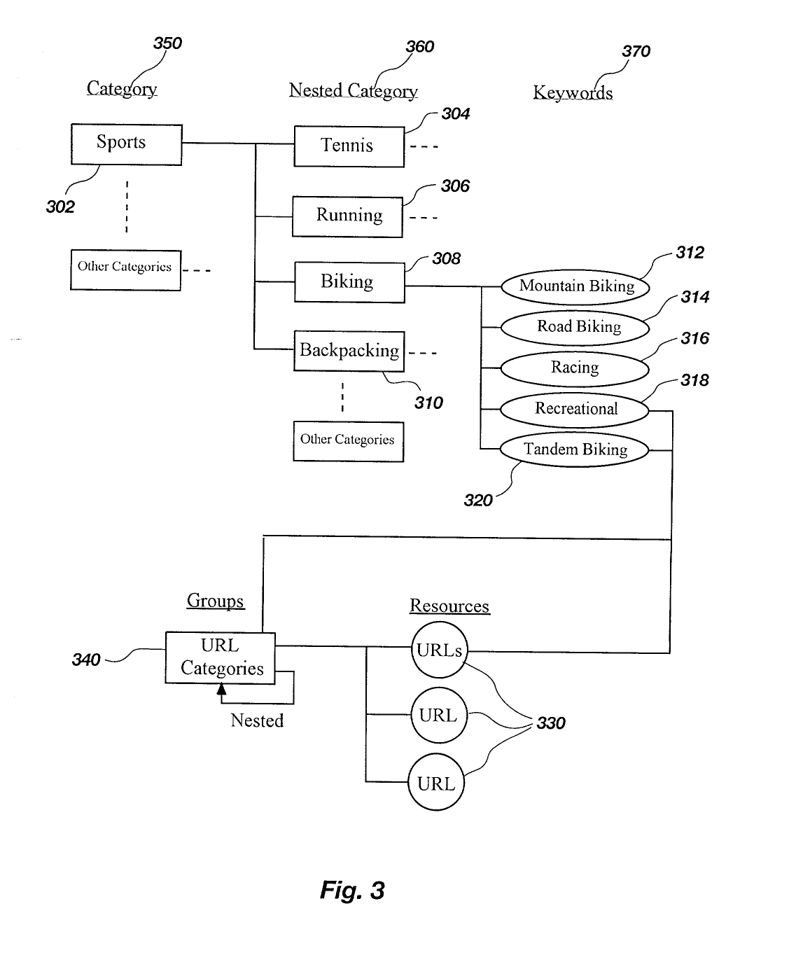

FIG. 3 provides an overview of the details of the system for personalizing digital objects and content associated with a web page. The personalization system includes content categories 350 that are nested hierarchically 360 and are linked to a plurality of keywords 370. Resources 330 are also associated with a plurality of keywords. The personalization system tracks each user's activities by storing an activity level for keywords associated with each resource. This allows the users' activities to be tracked as the user accesses the resources or URLs. A user's content preferences are determined based on the activity level recorded for the relevant keywords across multiple categories. When the personalization system has determined the user's content preferences, digital objects associated with a web page are delivered to users based on the user's content preferences across multiple categories. The following example serves as concrete examples for the use of the hierarchical categorization scheme just described.

FIG. 3 illustrates the example of a sports category 302 which may be defined to contain the sub-categories: tennis 304, running 306, biking 308, and backpacking 310. The biking category, in turn, contains keywords such as mountain biking 312, road biking 314, racing 316, recreational 318, and tandem biking 320. It should be realized that the depth of the nested category is not limited, but it can be any number of levels desired by the system designer or users. In addition, the preferred embodiment of this invention only uses keywords at the lowest level of the hierarchy for a more uniform accounting of counts, but this invention may also use keywords associated with the parent categories or nested categories where appropriate.

One way to use the nested category keyword scheme for personalization is to allow the system or web server to query the database relative to a category context that contains more (sub) categories or a category context that contains only keywords. For example, one might make a query for the keyword with the maximum count under the “biking category” for a given user. If this “max keyword” turns out to be “mountain biking” for a certain user, then that user is probably a mountain biker.

Referring back to FIG. 2, while the cc_keyword 212 and cc_category 214 tables described above provide a framework to record customer behavior, the actual recording of the user's view count is stored in the cc record count table 210. All of a user's view counts are stored in the context of both the customer ID (or user ID) and the keyword ID. Accordingly, the activity associated with keywords is stored in a count representing the number of times a resource was accessed. This way we have a separate count of each keyword activity for every user or customer. The personalization system can also store a user activity level representing time or some other user activity metric.

The two remaining categorization tables that this invention focuses on are the cc_community 204 and the cc_community_customer 206 tables. They define the concept of communities of users that visitors can join. One feature of the schema is that there are no limits on the number of users who can join a community. Furthermore, there are no limits on the number of communities a user can join. User communities are most frequently based on a topic in which the community is interested. The personalization system captures an aggregate community's activities based on keywords associated with resources used by the aggregate community. This way web pages, digital objects, or components are delivered to a user based on the aggregated activity of a user community or aggregate community to which the user belongs. User communities can also be based on other associations such as family associations, work associations, or other similar aggregate groupings.

A benefit of enabling users to join communities is that one user's personalized page is based not only on one single user's behavior, but also on a whole community's behavior. This is especially useful for a new user or a user who does not have a long activity history upon which compelling personalization can be built. The ability to join communities and have personalized content be based on preferences collectively recorded for that community is a feature provided by the current invention.

When the ability exists to join a community and determine preferences based on the communities activities, the concept of community news can be explored. Suppose a “bike news” category exists with the keywords racing, touring, and sales. During the time before a major race, most of the members of the biking community would naturally be most interested in race related news, a fact that would be reflected by monitoring the activity level of the bike news category for the biking community. In this case, a member of the biking community subscribing to community-personalized news would automatically be directed to the race related news since the community currently deems that type of news most relevant. A community personalization based on this category allows a user to receive only the most compelling and relevant biking news as defined by the biking community as a whole for a given time.

Referring again to FIG. 2, the cb_group_keyword 216 and the cb_resource_keyword tables 218 are used here to illustrate one implementation of a method and system for creating cross-categorization. The point is to have a scheme where items, web pages, components, or digital objects on a website can be tagged with multiple keywords which allows components to be categorized in multiple categories. This flexibility is valuable in cross promotions on a website. For example, it is very useful to be able to categorize a water backpack promotion in multiple categories (e.g., under both the backpacking and the biking category). This also ensures that the activity level is extensively recorded since the user can be visiting the item due to either biking or backpacking interests.

As illustrated by FIG. 2, the rc_group 224, rc_group_resource 226, and the rc_resource 228 tables create a nested tree table schema described here as the resource component 222. Essentially a resource is an address that points to digital objects accessible on a public or private network such as an intranet. A group is a construct to group related resources together. Attaching multiple keywords to a resource or resource group resource allows the system to personalize content across multiple categories. FIG. 3 illustrates how resources 330 are linked to multiple keywords 312-320. The resources are grouped 340 into the nested tree schema as described above. This allows the personalization system to associate certain content or digital objects across multiple categories or groupings.

As described above, the content or digital objects are divided into content groups under hierarchical content categories. These groupings or content categories 340 may be linked to a plurality of keywords 312-320 (FIG. 3). Resources 330 refer to the digital objects and the resources that are associated with at least two keywords in separate categories. This association of resources with multiple keywords or groupings allows the personalization system to deliver the same digital objects to separate users based on users' activities in the separate categories.

### Personalization Component

A logging component on the web server is responsible for updating the count in the database for each personalization keyword or tag found on a web page. Logging occurs after page generation and before page delivery, as described in the flow chart of FIG. 1. In addition to updating the count in the database, the personalization component strips out the personalization tag before allowing the generated page to be sent to a users browser. The main advantages of the personalization component in the present system are the implementation of a weighted recording system and the use of the exponential decay algorithm. This allows the keywords that are associated with user activities to be weighted based on a date the user activity occurred for each user who belongs to the aggregate community.

### Interpreter Component

The interpreter component consists of a library of routines to implement frequently used personalization queries. The following list shows the base functions on which more complicated queries can be built.

get_sorted_result(category[, community]) keyword or category list

get_sorted_keywords(category[, community]) keywords or nothing

get_sorted_categories(category[, community]) categories or nothing

get_max(keyword or category list) keyword or category

get_min(keyword or category list) keyword or category

get_comnmunity() community list

For example, assume a user belongs to the recreational bicyclists community. To find the most popular type of biking for that community, one would call get_sorted_result(“biking”, “recreational bicyclists community”). Of course, the system would have already used the get_community() query in order to find out that the user belonged to the recreational bicyclists community.

The present interpreter component incorporates more functionality than a conventional interpreter component, because it includes the additional functionality for communities and cross category personalization. Outside of these new functions, the module is used during the page generation phase for generating custom web content.

As mentioned before, an important idea suggested by the current invention is that interest or activity counts should be stored relative to aggregations of users in or communities instead of just individual users. When interest counts are stored relative to user communities, not only can the individual user's browsing behavior be used to select the specific content that is delivered to the user in the future, but the collective behavior of the communities can be mined and analyzed to deliver target content to the individual user as well. Community personalization can be a powerful notion in the art of personalization. The community bike news embodiment shows one way to personalize content based on community preferences and/or behaviors. Similar types of personalization based on preferences shown by sets of communities can be easily devised.

The embodiment described here should not be seen to be limited to the type of personalization affected by the current invention. In general, the invention encourages the integration of any “click-stream” tracking personalization systems with a system that organizes users into useful user aggregations or communities to enable click-stream tracking to be systematically done on either a user or a community basis or both. The user communities can generally be explicitly defined by users and/or content editors, or implicitly discovered with artificial intelligence such as pattern recognition.

Once the tracking system, incorporates community counts, personalization can be delivered based on community preferences. In the current embodiment, community counts are derived from the user counts recorded in the cc_record_count table 210 (FIG. 2). An alternative approach is to record the community counts independently in a cc_community_record_count table (not shown) where all fields are similar to the cc_record_count table except that the CommunityID field replaces the CustomerID field. This means that the total counts can be kept for the community as a whole without tracking the individual users contribution to that count. A hybrid of the two approaches can be implemented for performance reasons where the count is recorded in the cc_record_count table, as in the first approach. Then the cc_community_record_count can be periodically refreshed and updated from the cc_record_count table so that subsequent personalization is based off the cc_record_count table, as in the second approach.

### Community Search Embodiment

An additional embodiment will now be discussed that further demonstrates the elements taught by the current invention. The embodiment involves a community search engine. A general search engine is an application that returns a generic set of results based on a set of keywords a user enters. A generic search result is a result set based only on the keywords a user enters. In contrast, a “best guess” search result is a result set derived (e.g. sorted or ordered) with artificial intelligence or other specialized techniques from the generic result set above. Such a derivation is often based on some user profile that suggests the type of documents in which a user might be most interested. The user profile can be either explicitly specified by the user or implicitly derived from user history or other user profiles.

With the application of the current invention, a search engine can be enhanced to deliver community based “best guess” search results, based on the generic search results that are relevant to specific communities of users. For example, suppose there is a community of Linux operating system users called Linux_Users. By joining a community such as Linux_Users, a user can receive “best guess” search results that reflect the interests of the Linux_Users community. When Linux community user searches for “pipes,” the results pertaining to the mechanism for the flow of information between two processes will receive higher precedence than say results relating to smoking pipes or plumbing pipes. The interests can also reflect changing interests of a community. When a user searches for operating system conferences, for example, the Linux 2000 conference will be presented with a higher precedence than the Linux 1995 conference.

The way a personalized search based on community preferences works is as follows. Each time a user of a community clicks on an item returned in a search result, an interest count is registered for that community, the search item, and the search context. A search context is a construct that identifies unique searches. For example, “network printer” and “scuba diving” constitute two completely unrelated searches and hence will be associated with two completely independent search contexts. Typically some algorithms are used to derive the search context, and these methods can range from the simple to the complex. For example, the searches for “networked printers,” “printers network,” and “network and printers” can be either categorized to be the same search (i.e. the same search context) or a different search (i.e. a difference search context) depending on the particular categorizing algorithms used. In general, the simplest algorithm is keyword based one where the algorithm might “normalize” the various keyword inputs by stripping away the various conjunctions, replacing all verbs with the present tense, and sorting on the remaining word set but otherwise keep the original search keywords input by the user. The more complicated algorithms might involve sophisticated Bayesian net or other artificial intelligence techniques that map input keywords onto the search contexts.

Each time a user clicks on a search item, the respective community count is incremented. A community count is uniquely identified by the community, search item, and search context. The cumulative community count is then used to customize future user search results. When the user initiates a search in the future, the user gets a filtered best guess result set based on communities to which he belongs. Typically, whenever a search is made, a generic result set is first returned and compared against the items (or search contexts) recorded in the community counts table. If an item exists in the community counts table, the item is given a weight proportional to that count. If an item does not exist in the count table, it is given no extra weight. The “best guess” search result is then derived from the generic search result by sorting the generic search result set according to the assigned weight. In general, other weighting schemes, in addition to the weighting derived from the community counts, can be assigned and used.

### Community Shopping Embodiment

Another embodiment of the current invention involves a community shopping e-commerce application. Most people tend to want to buy items that are in fashion. Clothes or music store promotions are often based on what the store believes to be fashionable for the customers. Often individuals do not trust stores to make the final decision on what is in fashion, and many end up also buying items in a piecemeal fashion from many sources. A community shopping mall can be the solution. People can join various communities such as “high fashion”, “conservative”, “teen”, etc. A count is then kept for items that are purchased by the various groups of users. As the count matures, the community shopping mall can promote the items most popular to the relevant communities, based on the membership of each user.

It is important to note that this embodiment is very different from the “people who bought this item are also interested in these other items” mechanism often seen in many of today's commercial web sites. Such systems are based on a correlation obtained from customer receipt data mining. In that case, everyone who bought the same item (or set of items) will see the same suggested list_which is not personalized to each user. In the current embodiment, the promotion list is customized for each user based on the community or communities to which the user belongs. With this approach, every user can conceivably receive a different promotion list.

Community based personalization can be a very powerful concept. The embodiments above demonstrate some of the applications resulting from the current invention. It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention with respect to current technologies and state of art, it will be apparent to those of ordinary skill in the art that numerous modifications, including, but not limited to, form, function and manner of operation, implementation and use may be made, without departing from the principles and concepts of the invention as set forth in the claims.

What is claimed is:

1. A method for personalizing digital objects and content associated with a digital document, for users who belong to an aggregate community, comprising the steps of:
accessing categories that include a plurality of keywords associated with the categories;
associating a plurality of resources with the keywords, wherein the resources refer to digital objects;
recording user activity levels for keywords when the associated resources are accessed by the users who belong to the aggregate community;
prioritizing the user activity levels for keywords within the aggregate community; and
delivering digital objects to users based on the aggregate community's keywords that have high user activity levels.

2. A method as in claim 1, further comprising the step of weighting user activities associated with keywords, based on a time period that has passed since user activity occurred for users belonging to the aggregate community.

3. A method as in claim 1, further comprising the step of delivering digital objects to users based on an aggregated activity of a topic based user community to which users belong.

4. A method as in claim 1, wherein the step of recording resources accessed by the users, further comprises the step of recording the activity level of the resources accessed by users on an aggregate community basis.

5. A method as in claim 1, wherein the step of recording resources accessed by the users, further comprises the step of recording the resources accessed by users individually which are then aggregated to determine the resources accessed for the aggregate community.

6. A method as in claim 1, further comprising the step of allowing an unlimited number of users to join a community.

7. A method as in claim 1, further comprising the step of allowing a user to join an unlimited number of communities.

8. A method as in claim 1, further comprising the step of defining the aggregate community using pattern recognition.

9. A method as in claim 1, further comprising the step of defining the aggregate community by allowing users to define the aggregate community.

10. A method as in claim 1, further comprising the step of defining the user community by allowing content editors to define the aggregate community.

11. A method for personalizing digital objects and content associated with a digital document sent to a user who belongs to an aggregate community, comprising the steps of:
accessing categories that include a plurality of keywords connected to categories;
associating a plurality of resources with the keywords, wherein the resources refer to digital objects;
tracking an aggregate community's activities based on the resources accessed by the aggregate community; and
delivering digital objects to a user based the aggregate community's activities.

12. A method as in claim 11, further comprising the step of weighting activity associated with keywords based on a time period that has passed since user activity occurred for each user belonging to the aggregate community.

13. A method as in claim 11, further comprising the step of delivering digital objects to a user based on an aggregated activity of a topic based user community to which the user belongs.

14. A method as in claim 11, wherein the step of capturing an aggregate community's activities, further comprises the step of recording activity levels for the resources accessed by a plurality of users within the aggregate community.

15. A method as in claim 11, wherein the step of capturing an aggregate community's activities, further comprises the step of recording activity levels for the resources accessed by each of a plurality of users individually, which are then aggregated to determine the resources accessed for the aggregate community.

16. A method for personalizing digital objects and content associated with electronic search results for users who belong to an aggregate community, comprising the steps of:
organizing a plurality of search contexts that maps at least one keyword to each search context;
associating a plurality of resources with the at least one keyword;
recording the resources accessed by the users for a search context in relation to the aggregate community to which the users belong; and
delivering search results to the users based on the aggregate community's activities for resources that were previously accessed.

17. A method as in claim 16, further comprising the step of weighting search results based on activity levels for search contexts associated with the aggregate community.

18. A method as in claim 17, further comprising the step of ranking the search results based on the weighting received.

19. A method as in claim 16, further comprising the step of incrementing an activity count each time a user who belongs to an aggregate community uses the same search context and selects a resource displayed by the electronic search results.

20. A method for personalizing digital objects and news content associated with a digital document, for users who belong to an aggregate community, comprising the steps of:
accessing categories that include a plurality of keywords associated with the categories;
associating a plurality of resources with the keywords, wherein the resources refer to digital objects;
recording user activity levels for keywords when the associated resources are accessed by the users who belong to the aggregate community;
prioritizing the user activity levels for keywords within the aggregate community; and
delivering personalized digital objects containing news, to users based on the aggregate community's activities.

21. A method as in claim 20, wherein the step of delivering personalized digital objects containing news, further comprises the step of delivering digital objects containing news to users based on the aggregate community's keywords that have high user activity levels.

22. A method for delivering personalized digital objects and shopping items associated with electronic shopping to users who belong to an aggregate shopping community, comprising the steps of:
associating a user with an aggregate shopping community;
associating a plurality of resources with the digital objects and shopping items;
recording the resources accessed by the users in relation to the aggregate shopping community to which a user belongs; and
delivering a shopping promotion to users based on the aggregate shopping community's activities.

23. An article of manufacture, comprising:
a computer usable medium having computer readable program code means embodied therein for personalizing digital objects and content associated with a digital document sent to users across a network, the computer readable program code means in said article of manufacture comprising:computer readable program code means for accessing categories that include a plurality of keywords associated with the categories;
computer readable program code means for associating a plurality of resources with the keywords, wherein the resources refer to digital objects;
computer readable program code means for recording user activity levels for keywords when the associated resources are accessed by the users who belong to the aggregate community; and
computer readable program code means for prioritizing the user activity levels for keywords within the aggregate community; and
computer readable program code means for delivering digital objects to users based on the aggregate community's keywords that have high user activity levels.
